(19) United States
(12) Patent Application Publication
(10) Pub. No.: US 2014/0176291 A1
(43) Pub. Date: Jun. 26, 2014

(54) CHOKE COIL

(71) Applicants: Xiaoguang Zheng, Osaka-shi (JP); Shingo Ohashi, Osaka-shi (JP)

(72) Inventors: Xiaoguang Zheng, Osaka-shi (JP); Shingo Ohashi, Osaka-shi (JP)

(73) Assignees: SUMITOMO ELECTRIC INDUSTRIES, LTD., Osaka-shi (JP); AUTONETWORKS TECHNOLOGIES, LTD., Yokkaichi-shi (JP); SUMITOMO WIRING SYSTEMS, LTD., Yokkaichi-shi (JP)

(21) Appl. No.: 14/236,312

(22) PCT Filed: Jan. 20, 2012
(86) PCT No.: PCT/JP2012/051179

§ 371 Date: Jan. 30, 2014

(30) Foreign Application Priority Data
Aug. 1, 2011 (JP) 2011-168466

(51) Int. Cl. H01F 3/08

(52) U.S. Cl. CPC H01F 3/08
USPC 336/233

(57) ABSTRACT

A choke coil of the present invention employs a dust core as a material for each core, and includes an outer core having a quadrangular frame shape, a bobbin on which a coil is wound and which is mounted in the frame of the outer core, and an inner core which serves as a magnetic core of the bobbin and which has a core-rod-like shape having a central axis parallel to the winding axial direction of the coil. The inner core is interposed between two flat surfaces facing each other in the inner face of the outer core such that the central axis extends in a direction orthogonal to the two flat surfaces.

### TECHNICAL FIELD

The present invention relates to choke coils mainly used for boosting, improving power factors, or smoothing currents in power circuits.

### BACKGROUND ART

Choke coils are used for boosting, improving power factors, or smoothing currents in power circuits, for example. A conventional choke coil has a configuration in which a pair of cores and a bobbin on which a coil is wound are coupled with each other. For example, as a core shape for a ferrite core, ER cores are known (see PATENT LITERATURE 1, for example). FIG. 15 is an exploded perspective view showing an example of a structure of a choke coil 100 of an ER core-type. In FIG. 15, the choke coil 100 includes a pair of upper and lower cores 101, and a bobbin 102 having a cylindrical shape on which a coil 103 is wound.

Each core 101 includes projecting parts 101a at both ends thereof and a cylindrical part 101b at the middle thereof such that the core 101 has a projecting and recessed shape that fits the outer peripheral shape of an annular collar 102a provided at each of both ends in the axial direction of the bobbin 102 and the shape of a hole 102bformed at the center of the bobbin 102. In a state where the cylindrical parts 101b of the pair of upper and lower cores 101 are inserted in the hole 102b and the projecting parts 101a on the outer side abut against each other, if all of them are fixed together, the choke coil 100 is constructed. It should be noted that, for example, the choke coil 100 is configured such that the cylindrical parts 101b do not abut against each other with the projecting parts 101a on the outer side abutting against each other, thereby forming a certain gap. The presence of the gap suppresses magnetic saturation.

Further, EE cores different from ER cores are also well known (see PATENT LITERATURE 2, for example). FIG. 16 is a perspective view showing an example of a structure of a choke coil 200 of an EE core-type. In FIG. 16, the choke coil 200 includes a pair of upper and lower cores 201 and a bobbin 202 having an angled shape on which a coil 203 is wound.

Each core 201 includes projecting parts 201a at both ends thereof and a projecting part 201b at the middle thereof such that the core 201 has a projecting and recessed shape that fits the outer shape of a quadrangular collar 202a provided at each of both ends in the axial direction of the bobbin 202 and the shape of a hole 202b formed at the center of the bobbin 202. In a state where the projecting parts 201b at the middle of the pair of upper and lower cores 201 are inserted in the hole 202b and the projecting parts 201a on the outer side abut against each other, if all of them are fixed together, the choke coil 200 is constructed. It should be noted that, for example, the choke coil 200 is configured such that the projecting parts 201b in the middle do not abut against each other with the projecting parts 201a on the outer side abutting against each other, thereby forming a certain gap.

### CITATION LIST

### Patent Literature

PATENT LITERATURE 1: Japanese Laid-Open Patent Publication No. 2010-267816 (FIG. 1, FIG. 4)

PATENT LITERATURE 2: Japanese Laid-Open Patent Publication No. 2005-150414

### SUMMARY OF INVENTION

### Technical Problem

As materials for cores, silicon steel plate, ferrite, or amorphous ribbon has been used in general. However, herein, it is desired to manufacture a choke coil using a dust core (powder magnetic core) instead of these materials. A dust core has an advantage that loss in high frequency area is small and saturation flux density is relatively high.

However, when an ER core is to be manufactured using a dust core, since the shape of the core is complicated, the ER core cannot be press molded by one stroke, and advanced pressing steps in which numerical values are controlled by use of an NC press machine are required. This results in high molding costs. Further, since the shape is complicated, there are many sites where local stress concentration is likely to occur. Therefore, the core is easy to break, resulting in insufficient mechanical strength.

On the other hand, when an EE core is to be manufactured using a dust core, the cross sectional shape of the core when viewed from a direction in which the core looks like an E shape is always an E shape. Thus, press molding the EE core is easier than in the case of the ER core, and the EE core can be easily molded even by a low-cost oil hydraulic press. However, in the entirety of a pair of cores, there are many corner portions where stress concentration is likely to occur. Thus, it cannot be said that the EE core has sufficient mechanical strength. Further, in the case of the EE core, since its bobbin has an angled shape, there is a unique problem that it is difficult to wind a coil without making it outwardly protrude.

In view of the above problems, an object of the present invention is to provide a choke coil that has a simple structure being neither the structure of a conventional ER core nor the structure of a conventional EE core, and that is easy to ensure the mechanical strength of its core.

### Solution to Problem

(1) A choke coil of the present invention is a choke coil including: an outer core made of a dust core, the outer core having a quadrangular frame shape at least on an inner face side thereof; a bobbin on which a coil is wound and which is mounted in the frame of the outer core; and an inner core made of a dust core for serving as a magnetic core of the bobbin, the inner core forming a core-rod-like shape having a central axis parallel to a winding axial direction of the coil, the inner core being interposed between two flat surfaces facing each other in the inner face of the outer core such that the central axis extends in a direction orthogonal to the two flat surfaces.

In the choke coil structured as described above, since the outer core and the inner core are made of members different from each other, their shapes are simplified. In the outer core, the shape at least on the inner face side is a quadrangular frame shape, and the inner core has a core-rod-like shape. Thus, the outer core and the inner core both have simple shapes and are easy to be molded. Further, since the shapes are simple, occurrence of local stress concentration can be suppressed, and mechanical strength can be easily ensured although dust cores are used. The outer core having a quadrangular frame shape and the inner core having a core-rod-like shape can be easily configured such that the frame shape of the outer core and the shape of the cross section of the inner core orthogonal to the central axial direction thereof remain constant in any cross section. Thus, press molding of each core is easy.

(2) Further, the choke coil according to (1) above may be configured such that, by the inner core being inserted into a hole formed in a middle of the bobbin, to be housed at a predetermined position therein, one end portion in a direction of the central axis of the inner core abuts against one of the two flat surfaces, and the other end portion in the direction of the central axis of the inner core faces the other of the two flat surfaces while forming a predetermined magnetic gap.

In this case, if the bobbin with the inner core inserted in the hole of the bobbin and housed at a predetermined position therein is mounted in the frame of the outer core, one end of the inner core can abut against the outer core, and the other end of the inner core can provide a predetermined gap between the other end of the inner core and the outer core. Accordingly, dimension management of the gap becomes easy.

(3) Further, the choke coil according to (2) above may be configured such that the hole is a hole-with-bottom, and the other end portion faces the other of the two flat surfaces via a thickness of a bottom of the hole-with-bottom.

In this case, a gap defined by the thickness of the bottom can be provided, and thus, dimension management of the gap becomes easy in particular.

(4) The choke coil according to (2) or (3) above may be configured such that collars are respectively formed at both ends of the bobbin, the collar at one end thereof is thicker than the collar at the other end thereof, and the gap exists on the collar at one end side.

In this case, the thicker collar contributes to locating the coil on the gap side slightly away from the outer core. Thus, the amount of leakage magnetic flux to which the coil is exposed can be reduced. Accordingly, the loss of choke coil can be suppressed.

(5) Further, with respect to the choke coil according to (4) above, in the collar at one end, a recessed portion along which a winding end of the coil is laid may be formed.

In this case, since the thicker collar has a sufficient thickness, the recessed portion can be easily formed.

(6) In the choke coil according to any one of (1) to (3) above, the inner core may be divided into a plurality of pieces in the direction of the central axis thereof, and a member which serves as a magnetic gap may be sandwiched between the plurality of pieces.

In this case, if a non-magnetic material is employed as the member, for example, the magnetic gap can be ensured by the inner core itself.

(7) Further, in the choke coil of any one of (1) to (3) above, the bobbin may be provided with a positioning part for aligning the central axis of the inner core to a center of each of the two flat surfaces.

In this case, the central axis of the inner core can be easily aligned to the center of each of the two flat surfaces, and thus, it is possible to cause magnetic flux to pass through the outer core in a balanced manner.

(8) Further, the choke coil according to any one of (1) to (3) above may be configured such that a portion of an outermost layer of the coil wound on the bobbin is exposed to a one end face side of the frame of the outer core, and is present further inside the outer core relative to the one end face, and a heat dissipation member is provided so as to face the one end face and the portion of the outermost layer.

In this case, the one end face of the outer core and the portion of the outermost layer of the coil both face the heat dissipation member, and in addition, the portion of the outermost layer does not protrude further out than the one end face. In such a state, with respect to the outer core, by bringing the one end face into contact with the heat dissipation member, a heat conducting path for heat dissipation can be easily formed. Further, with respect to the coil, by bringing the portion of the outermost layer into contact with the heat dissipation member via a heat conducting material such as a heat dissipation sheet, a shortest heat conducting path for heat dissipation can be formed. Accordingly, excellent heat dissipation effect can be obtained in that heat generated by the coil can be conducted to the heat dissipation member, not only via the outer core but also from the outermost layer of the coil.

(9) Further, in the choke coil according to any one of (1) to (3) above, preferably, each of the dust cores respectively forming the outer core and the inner core is obtained by subjecting soft magnetic powder coated with insulation coating to compression molding and thermal treatment, and an average particle diameter of the soft magnetic powder is about 150 μm.

The dust core in this case has reduced magnetic anisotropy, and thus is preferable as a material for a core of a choke coil.

(10) Further, in the choke coil according to any one of (1) to (3) above, preferably, a shape of a cross section of a site of the bobbin on which the coil is wound, the cross section being orthogonal to the winding axial direction, is a rounded outwardly-protruding curve including a circle and an ellipse, or a polygon whose corners are rounded.

In this case, these shapes do not have sharp corners when compared with a case where the cross sectional shape is a polygon with corners such as a quadrangle or the like, and thus, it is easier to bring the coil into close contact with the site. Further, for example, a shape of an ellipse or a rectangle whose corners are rounded has variation in the radius of curvature or in the length of sides of the rectangle in the winding direction, and thus, the wounded coil is less likely to become loose. Accordingly, winding of the coil is easy. In this case, by also causing the inner core to have a similar shape, the distance between the coil and the inner core can be made uniform per turn of the coil.

(11) Further, in the choke coil according to any one of (1) to (3) above, the coil and the bobbin may be molded together by filling a resin between both end faces of the frame of the outer core.

In this case, the surface of the mold part is exposed on the outer face of the entirety of the choke coil. Thus, by bringing this surface into contact with the heat dissipation member, heat dissipation of the coil can be realized via the mold part.

### Advantageous Effects of Invention

According to the choke coil of the present invention, mechanical strength of the core can be easily ensured by a simple structure that is neither the structure of a conventional ER core nor the structure of a conventional EE core.

### BRIEF DESCRIPTION OF DRAWINGS

FIG. 1 is a perspective view showing a structure of a choke coil according to an embodiment of the present invention, in which (a) shows a bobbin, (b) shows a state of the choke coil being assembled, and (c) shows the choke coil having been assembled.

FIG. 2 is a cross sectional view of the bobbin on which a coil is wound and in which an inner core is inserted.

FIG. 3 is a cross sectional view showing the choke coil in the state of (c) of FIG. 1 to which a configuration for heat dissipation is added.

FIG. 4 is a cross sectional view showing an example in which the choke coil in the state of (c) of FIG. 1 is provided with a configuration for heat dissipation other than that shown in FIG. 3.

FIG. 5 is a circuit diagram showing an example of a power circuit (showing only a main circuit part) to be mounted on an electric vehicle or a hybrid electric vehicle for charging an on-vehicle battery.

FIG. 6 is a perspective view showing a modification of an outer core in the choke coil shown in FIG. 1.

FIG. 7 is a schematic diagram showing two examples of cross sectional shapes of the inner core and a core body of the bobbin.

FIG. 8 is a perspective view showing another structure of the inner core.

FIG. 9 is a perspective view showing the bobbin according to a variation.

FIG. 10 is a cross sectional view of the bobbin viewed from the X-X line shown in FIG. 9.

FIG. 11 is a partial cross sectional view showing a state where the bobbin shown in FIG. 10 on which the coil is wound is mounted in the outer core.

FIG. 12 shows the bobbin according to another variation, in which (a) is a cross sectional view thereof, and (b) is a side view thereof viewed from one collar side.

FIG. 13 is a cross sectional view of a choke coil in a case where the bobbin of the type shown in FIG. 12 is used.

FIG. 14 shows types of a cross sectional shape of a coil.

FIG. 15 is an exploded perspective view showing an example of a structure of a conventional choke coil of an ER core-type.

FIG. 16 is a perspective view showing an example of a structure of a conventional choke coil of an EE core-type.

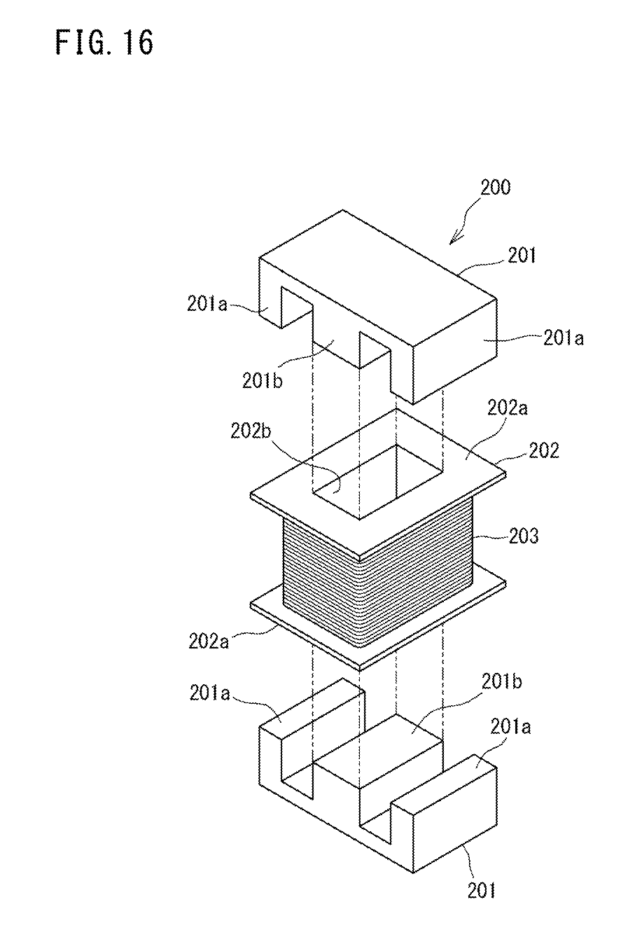

### DESCRIPTION OF EMBODIMENTS

Hereinafter, a choke coil according to an embodiment of the present invention will be described with reference to the drawings.

<Example of Circuit Using Choke Coil>

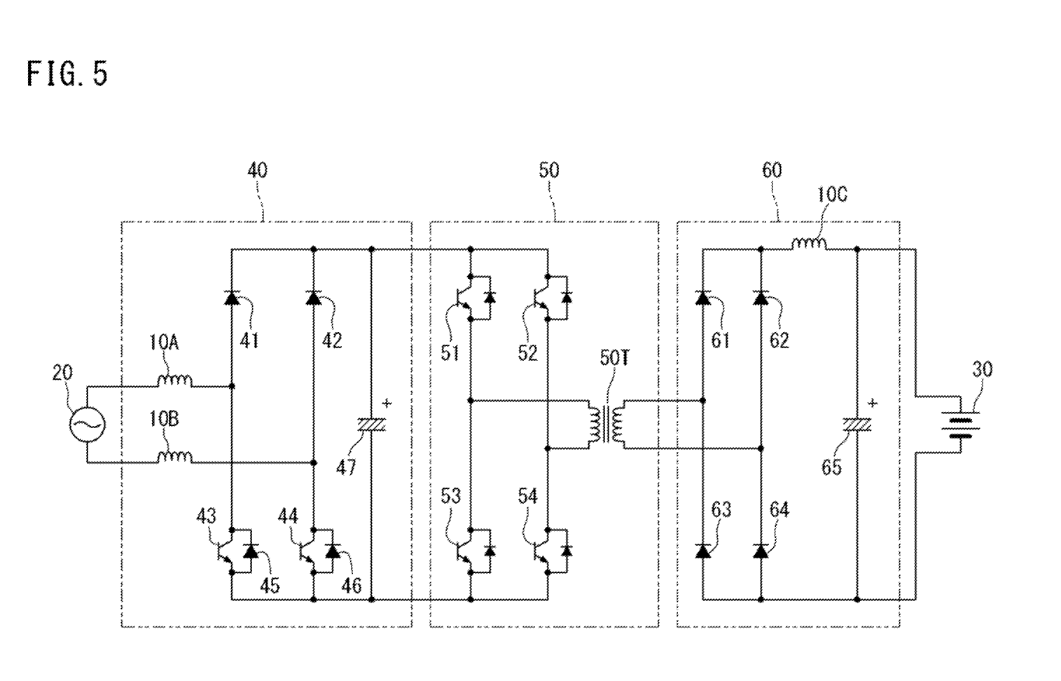

First, a typical usage of the choke coil will be described. FIG. 5 is a circuit diagram showing an example of a power circuit (showing only a main circuit part) to be mounted on an electric vehicle (EV) or a plug-in type hybrid electric vehicle (HEV) for charging an on-vehicle battery. This power circuit charges an on-vehicle battery 30 (DC 340 V, for example) by use of a commercial power 20 (AC 100 V or 200 V) supplied to general households and the like.

In FIG. 5, the power circuit includes a rectifying/boosting circuit 40, a transforming/insulating circuit 50, and a rectifying/smoothing circuit 60. The rectifying/boosting circuit 40 includes a pair of choke coils 10A and 10B, diodes 41 and 42, switching elements 43 and 44 and diodes 45 and 46 connected in inverse-parallel thereto, and a smoothing capacitor 47. The transforming/insulating circuit 50 includes four switching elements 51 to 54, and a transformer 50T. The rectifying/smoothing circuit 60 includes four diodes 61 to 64, a choke coil 10C, and a smoothing capacitor 65. The transforming/insulating circuit 50 and the rectifying/smoothing circuit 60 form a full-bridge converter which performs DC-DC conversion.

In the power circuit as described above, an AC voltage of the commercial power 20 becomes a DC voltage boosted by the rectifying/boosting circuit 40. The choke coils 10A and 10B contribute to boosting and improvement of the power factor. A boosted DC voltage is smoothed by the smoothing capacitor 47 to be outputted. The outputted DC voltage (about 400 V, for example) is converted into a DC voltage appropriate for charging the on-vehicle battery 30, by the full-bridge converter formed by the transforming/insulating circuit 50 and the rectifying/smoothing circuit 60. The choke coil 10C contributes to smoothing a current.

<Structure of Choke Coil>

Next, structural features of the choke coils 10A, 10B, and 10C above will be described in detail.

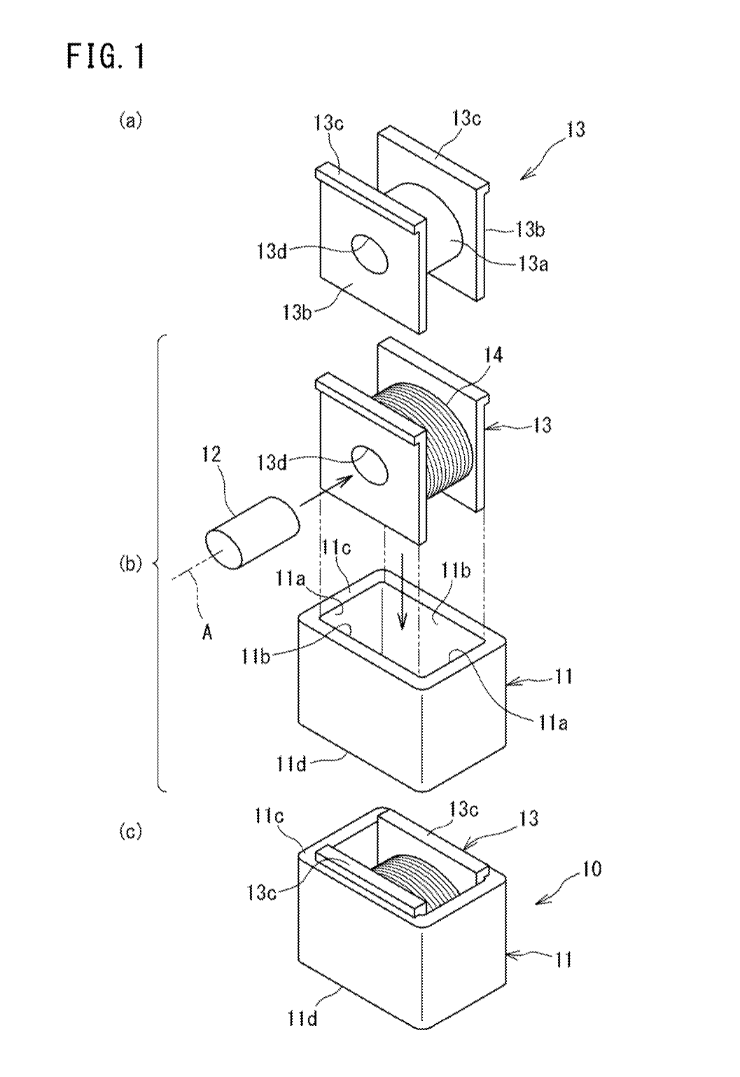

FIG. 1 is a perspective view showing a structure of a choke coil according to an embodiment of the present invention, in which (a) shows a bobbin, (b) shows a state of the choke coil being assembled, and (c) shows the choke coil having been assembled. A choke coil 10 includes an outer core 11, an inner core 12, a bobbin 13, and a coil 14 as major components.

First, the outer core 11 shown in (b) of FIG. 1 is made of a dust core (powder magnetic core), and is formed in a quadrangular frame shape (or angled pipe shape) as shown. The inner face of the outer core 11 into which the bobbin 13 is inserted includes two sets of flat surfaces, i.e., a pair of flat surfaces 11a facing each other and a pair of flat surfaces 11b facing each other. Each of end faces 11c and 11d (both end faces in the axial direction when the outer core 11 is viewed as a “pipe”) of the frame of the outer core 11 has a quadrangular shape as a whole. Strictly speaking, at each of four corners of the inner periphery and outer periphery of the outer core 11, roundness having an arc shape necessary for molding is formed. However, it is assumed that such details do not affect the outer core 11 having the “quadrangular frame shape”. In other words, the “quadrangular frame shape” described above means a basic shape represented by the outer core 11.

Further, the inner core 12, being a counterpart of the outer core 11, is similarly made of a dust core, and is formed in an elliptical core-rod-like shape, for example. The inner core 12 serves as a magnetic core of the bobbin 13.

On the other hand, the bobbin 13 shown in (a) of FIG. 1 is a molded article using, for example, PBT (polybutylene terephthalate) as its material, or is obtained by joining such molded articles. The bobbin 13 is composed of a core body 13a on which the coil 14 is wound, and angled collars 13b formed at both ends thereof. The core body 13a has a pipe-like shape whose cross section orthogonal to its central axial direction, i.e., the winding axial direction when the coil 14 is wound, has an elliptical shape. A hole-with-bottom 13d is formed at a middle portion of the bobbin 13 so as to continue from the collar 13b on the side of the viewer of the FIG. 1 to the inner face of the core body 13a. It should be noted that the collar 13b on the other side serves as the “bottom” of the hole-with-bottom 13d. On the upper end of each of the collars 13b, a positioning part 13c is formed which slightly protrudes in an outward direction orthogonal to the main flat surface of the collar 13b.

On the core body 13a of the bobbin 13, as shown in (b) of FIG. 1, the coil 14 is wound by a predetermined number of turns. The inner core 12 is tightly inserted into the hole-with-bottom 13d of the bobbin 13. A central axis A of the inner core 12 inserted therein is parallel to (substantially aligned with) the winding axial direction of the coil 14. When the bobbin 13 on which the coil 14 has been wound and into which the inner core 12 has been inserted is inserted into the outer core 11 in the direction indicated by the arrow in (b) of FIG. 1, the bobbin 13 is mounted in the frame of the outer core 11 as shown in (c) of FIG. 1.

As indicated by chain double-dashed lines in (b) of FIG. 1, the width dimension (longer one) of the bobbin 13 when the bobbin 13 excluding the positioning part 13c is inserted is the same as the inside dimension of the outer core 11 excluding corresponding radii of curvature R, each radius of curvature R being provided at each of four corners in the inner periphery of the outer core 11, (dimension obtained by subtracting 2R from the distance between the two flat surfaces 11a facing each other), and the depth dimension (shorter one) of the bobbin 13 when the bobbin 13 excluding the positioning part 13c is inserted is the same as the inside dimension of the outer core 11 (dimension between the two flat surfaces 11b facing each other). As a result, the bobbin 13 can be tightly inserted and mounted to the outer core 11. In the state of (c) of FIG. 1, the inner core 12 is interposed between the two flat surfaces 11b facing each other in the inner face of the outer core 11 such that the central axis A extends in a direction orthogonal to the two flat surfaces 11b.

<Detail of Dust Core>

The dust cores forming the outer core 11 and the inner core 12 described above are each produced by subjecting a raw material that includes soft magnetic powder being pulverized powder, insulation coating which coats the surface of the soft magnetic powder, and a binder, to compression molding and thermal treatment. As the soft magnetic powder, pure iron (Fe), or a Fe—Si alloy system or a Fe—Si—Al alloy system including iron is appropriate. Further, a Fe—Si—B alloy system (amorphous dust core) can also be used.

Specifically, the soft magnetic powder in the present embodiment contains iron (Fe) being the principal component, and silicon (Si) by about 9.5% by weight and aluminium (Al) by about 5.5% by weight. The insulation coating which coats the soft magnetic powder is obtained by heat-curing a silicone resin. Further, the binder is an acrylic resin. The average particle diameter of the soft magnetic powder is preferably not less than 30 μm and not greater than 500 μm, and is about 150 μm in the present example. By employing the average particle diameter of the present example, magnetic anisotropy is reduced, which is preferable for a material for a core of a choke coil. Press for molding was performed at room temperature at a pressure of 10 [t/cm²]. After the molding, thermal treatment was performed in nitrogen atmosphere at 750° C. for one hour.

That is, major production steps of a dust core described above include three steps: (1) a step of coating soft magnetic powder with insulation coating, and then mixing a binder to the resultant soft magnetic powder; (2) a pressing step; and (3) a thermal treatment step. For comparison, production steps of an amorphous ribbon requires at least five steps: (i) cold rolling, (ii) laminating/winding, (iii) bonding (heating, pressing), (iv) cutting, and (v) thermal treatment. That is, advantageously, the dust core requires fewer production steps than the amorphous ribbon.

Further, in the case of the amorphous ribbon, magnetic flux is easy to pass along the flat surface of the ribbon, and thus, strong magnetic anisotropy is likely to occur. Therefore, if it is supposed that the outer core 11 and the inner core 12 are made of amorphous ribbons in the structure shown in FIG. 1, eddy currents occur in the outer core 11 facing end faces of the inner core 12, causing a large eddy-current loss. In this point, in the case of a dust core which causes less anisotropy, an eddy current is less likely to occur.

<Detail of Bobbin>

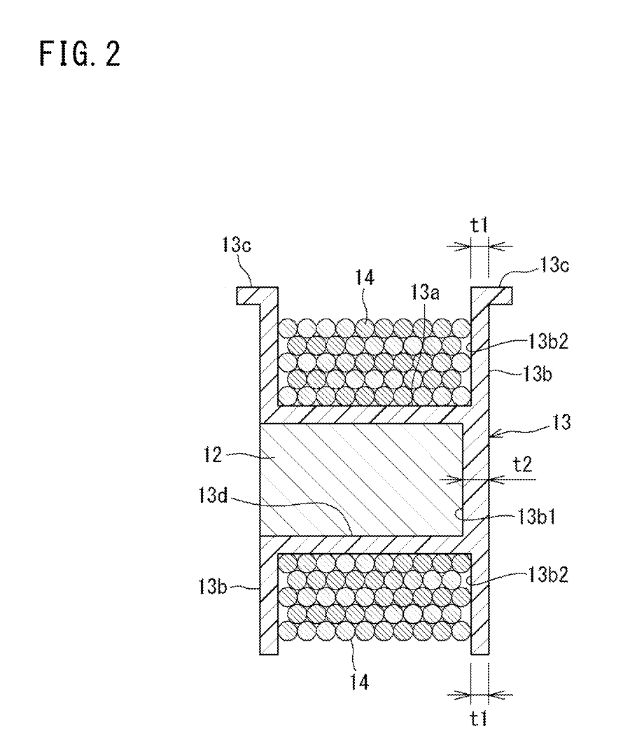

FIG. 2 is a cross sectional view of the bobbin 13 on which the coil 14 is wound and in which the inner core 12 is inserted and housed at a predetermined position therein. In FIG. 2, the outer face (excluding the positioning part 13c) of the collar 13b on the left is flush with the left end face of the inner core 12. On the other hand, the thickness of the collar 13b (excluding the positioning part 13c) on the right is not entirely uniform, since a thickness t2 of a middle portion 13b1 against which the right end face of the inner core 12 abuts and a thickness t1 of a surrounding portion 13b2 (portion which receives the coil 14 on a side face thereof) of the collar 13b other than the middle portion 13b1 are designed to be different from each other. That is, the thickness t1 is a thickness for mainly ensuring the strength of the collar 13b, whereas the thickness t2 is a thickness for defining a magnetic gap between the right end face of the inner core 12 and the outer core 11 closely facing thereto. Therefore, a necessary gap length is set as the thickness t2. It should be noted that the collar 13b on the left also has the same value of the thickness t1.

<Cross Section After Assembly Completed and Heat Dissipation Structure>

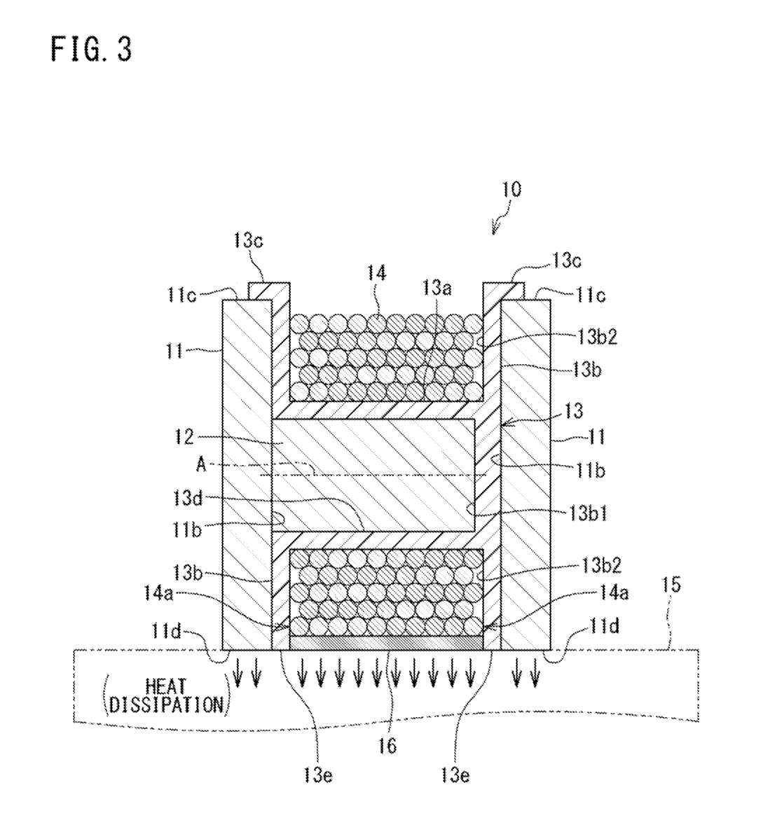

FIG. 3 is a cross sectional view showing the choke coil 10 in the state of (c) of FIG. 1 to which a configuration for heat dissipation is added. As a result of insertion of the bobbin 13, if the positioning parts 13c abut against the end face 11c at the top of the outer core 11, that position is the precise mounting position. At this mounting position, the central axis A of the inner core 12 is aligned with the center (the center in the up-down direction in the sheet of FIG. 3 and the center in the depth direction orthogonal to the sheet of FIG. 3) of each of the flat surfaces 11b of the outer core 11. In this manner, the central axis A of the inner core 12 can be easily aligned with the centers of the two flat surfaces 11b, and thus, it is possible to cause magnetic flux to pass through the outer core 11 in a balanced manner.

Further, in FIG. 3, the left end portion in the central axis A direction of the inner core 12 abuts against one (left) of the flat surfaces 11b of the outer core 11, and the right end portion in the central axis A direction of the inner core 12 faces the other (right) of the flat surfaces 11b via the thickness (t2 shown in FIG. 2) of the bottom of the hole-with-bottom 13d. That is, in a state where the inner core 12 is inserted in the hole-with-bottom 13d of the bobbin 13 and housed at a predetermined position therein, if the bobbin 13 is mounted in the frame of the outer core 11, one end of the inner core 12 can abut against the outer core 11, and the other end of the inner core 12 can provide a certain gap defined by the thickness (t2) of the bottom between the other end of the inner core 12 and the outer core 11. Accordingly, dimension management of the gap becomes easy.

Further, in FIG. 3, a portion-of-outermost-layer (portion in the lower part) 14a of the coil 14 is exposed to the end face 11d side of the frame of the outer core 11, and is present further inside the outer core 11 (upper in the drawing) relative to the end face 11d. Thus, a heat dissipation member 15 is provided which faces the end face 11d of the outer core 11 and the portion-of-outermost-layer 14a of the coil 14. The heat dissipation member 15 has a water jacket structure, for example, and can absorb and release heat to the outside. The heat dissipation member 15 abuts against the end face 11d in the lower part of the outer core 11. Further, a heat dissipation sheet 16 is sandwiched to be fixed between the portion-of-outermost-layer 14a of the coil 14 and the heat dissipation member 15. The heat dissipation sheet 16 is a heat conducting material excellent in heat conductivity and having a flexible sheet shape.

With such a configuration for heat dissipation, with respect to the outer core 11, a heat conducting path for heat dissipation can be easily formed by bringing the end face 11d into contact with the heat dissipation member 15. Further, with respect to the coil 14, a shortest (not via the outer core 11) heat conducting path for heat dissipation can be formed by bringing the portion-of-outermost-layer 14a into contact with the heat dissipation member 15 via the heat dissipation sheet 16. Therefore, excellent heat dissipation effect can be obtained in that, as indicated by the arrows in FIG. 3, heat generated by the coil 14 can be conducted to the heat dissipation member 15 not only via the outer core 11 but also from the outermost layer of the coil 14.

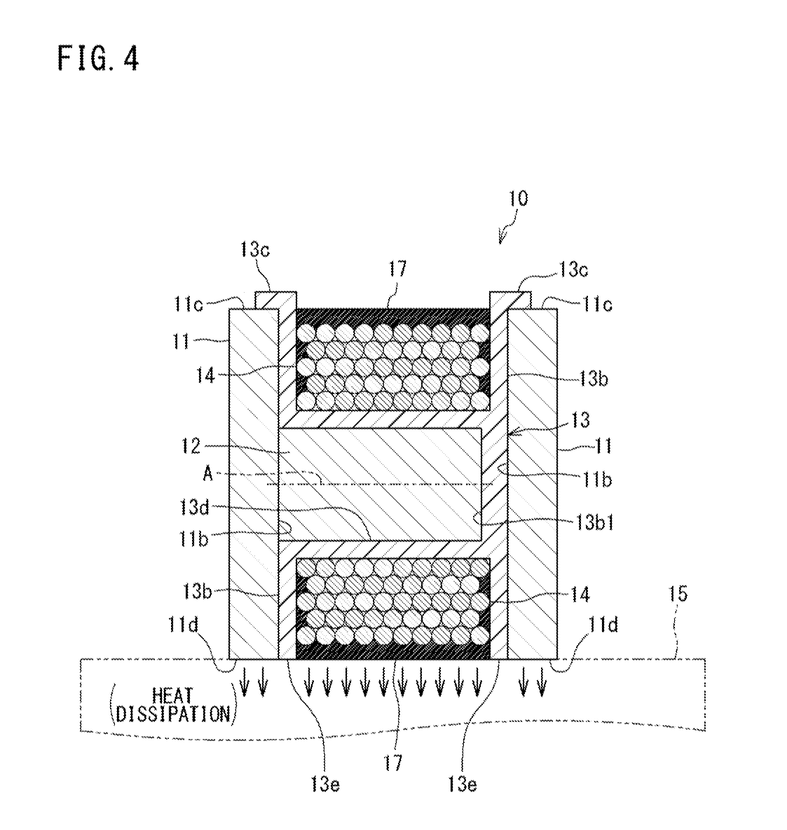

FIG. 4 is a cross sectional view showing an example in which a configuration for heat dissipation other than the heat dissipation sheet 16 shown in FIG. 3 is provided. In FIG. 4, the entirety of the coil 14 and the bobbin 13 are molded together by filling, for example, an epoxy resin between both end faces of the frame of the outer core 11. Through this molding, the space portion in the outer core 11 is filled with the epoxy resin, resulting in a state where surface of the mold part 17 is flush with each of the upper and lower end faces 11c and 11d (a state where the surface of the mold part 17 is exposed on the outer face of the entirety of the choke coil).

Then, by bringing the surface of the mold part 17 in the lower part of the outer core 11 into contact with the heat dissipation member 15, a shortest (not via the outer core 11) heat conducting path for heat dissipation which leads heat from the coil 14, to the heat dissipation member 15 can be formed. Accordingly, excellent heat dissipation effect can be obtained in that heat generated by the coil 14 can be conducted to the heat dissipation member 15 not only via the outer core 11 but also via the mold part 17.

<Summary>

As described above, according to the choke coil 10 of the embodiment above, since the outer core 11 and the inner core 12 are made of members different from each other, their shapes are simplified. Since the outer core 11 has a quadrangular frame shape and the inner core 12 has a core-rod-like shape, the outer core 11 and the inner core 12 both have simple shapes and are easy to be molded. Further, since the shapes are simple, occurrence of local stress concentration can be suppressed, and mechanical strength can be easily ensured although dust cores are used. Further, with respect to the outer core 11 having a quadrangular frame shape and the inner core 12 having a core-rod-like shape, the frame shape of the outer core 11 and the shape of the cross section of the inner core 12 orthogonal to the central axial direction thereof remain constant in any cross section. Thus, press molding of each core is easy.

Further, by the inner core 12 being inserted into the hole (the hole-with-bottom 13d) formed in the middle of the bobbin 13, to be housed at a predetermined position therein, one end portion in the direction of the central axis A of the inner core 12 abuts against one of the two flat surfaces 11b of the outer core 11, and the other end portion in the direction of the central axis A of the inner core 12 faces the other of the two flat surfaces 11b while forming a predetermined magnetic gap (corresponding to the thickness t2 in FIG. 2). That is, if the bobbin 13 with the inner core 12 inserted in the hole of the bobbin 13 and housed at a predetermined position therein is mounted in the frame of the outer core 11, one end of the inner core 12 can abut against the outer core 11, and the other end of the inner core 12 can provide a predetermined gap between the other end of the inner core 12 and the outer core 11. Accordingly, dimension management of the gap becomes easy.

Further, the shape of the cross section of the site (the core body 13a) of the bobbin 13 on which the coil 14 is wound, the cross section being orthogonal to the winding axial direction, is an ellipse. When compared with a case where the cross sectional shape is a polygon such as a quadrangle or the like, since an ellipse has no corners, it is easier to bring the coil 14 into close contact with the site. Further, when compared with a case where the cross sectional shape is a circle, an ellipse has variation in the curvature in the winding direction, and thus, the wounded coil 14 is less likely to become loose. Thus, winding of the coil 14 is easy. It should be noted that by causing the inner core 12 to have a cross sectional shape of a similar elliptical shape, the distance between the coil 14 and the inner core 12 can be made uniform per turn of the coil.

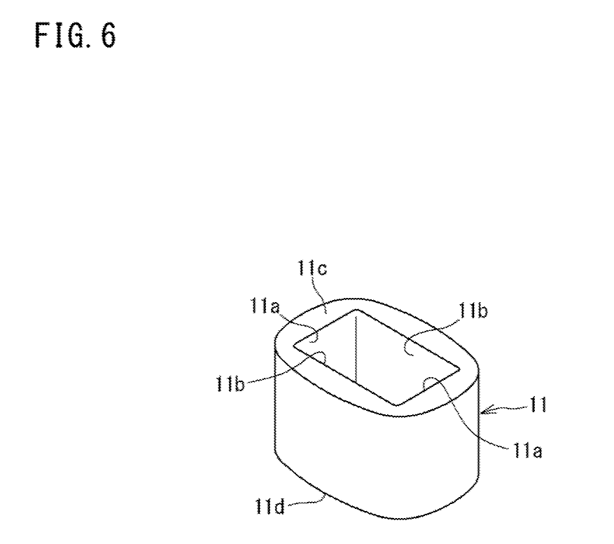

In the embodiment described above, each of the inner shape and the outer shape of the outer core 11 is a quadrangle, but the outer shape of the outer core 11 may not necessarily be a quadrangle. For example, in the case of the outer core 11 of a modification shown in FIG. 6, although the inner shape of the outer core 11 is a quadrangle and the inner face of the outer core 11 includes two sets of flat surfaces, i.e., a pair of the flat surfaces 11a and a pair of flat surfaces 11b as in the case of FIG. 1, the outer shape of the outer core 11 has a shape protruding in arc-like shape. Also in this case, similar basic action and effect brought by the fact that the shape is simple can be obtained. Due to the increased thickness and the roundness of the outer face, the mechanical strength is also expected to be increased.

Further, at each of four corners of the quadrangle of the inner shape of the outer core 11 shown in FIG. 1 and FIG. 6, a roundness having a radius of curvature corresponding to the thickness of each collar 13b of the bobbin 13 may be provided.

<Variation of Inner Core and Core Body of Bobbin>

In the embodiment described above, the cross sectional shape of each of the core body 13a of the bobbin 13 and the inner core 12 shown in FIG. 1 is an ellipse. This is advantageous in that the coil 14 can be easily wound as described above. However, the cross sectional shape thereof is not limited to an ellipse. For example, a circle or a curve similar to a circle or an ellipse may be employed. Further, even a polygon such as a rectangle or the like may be preferably used, if its contour is changed by rounding its corners into arc shapes.

In general, it is sufficient that the cross sectional shape (contour) of each of the core body of the bobbin 13 and the inner core 12 is a rounded outwardly-protruding curve including a circle and an ellipse, or a polygon whose corners are rounded. These shapes do not have sharp corners compared with a case where the cross sectional shape is a polygon with corners such as a quadrangle, and thus, it is easier to bring a coil into close contact. Further, a shape of a rectangle whose corners are rounded has variation in the length of the sides thereof in the winding direction. Thus, the wounded coil is less likely to become loose. Accordingly, winding of the coil is easy.

As described above, it is preferable that the cross sectional shape of the core body 13a and the cross sectional shape of the inner core 12 are in a relationship of similarity, in order to maintain uniformity of the magnetic distance between the coil 14 and the inner core 12.

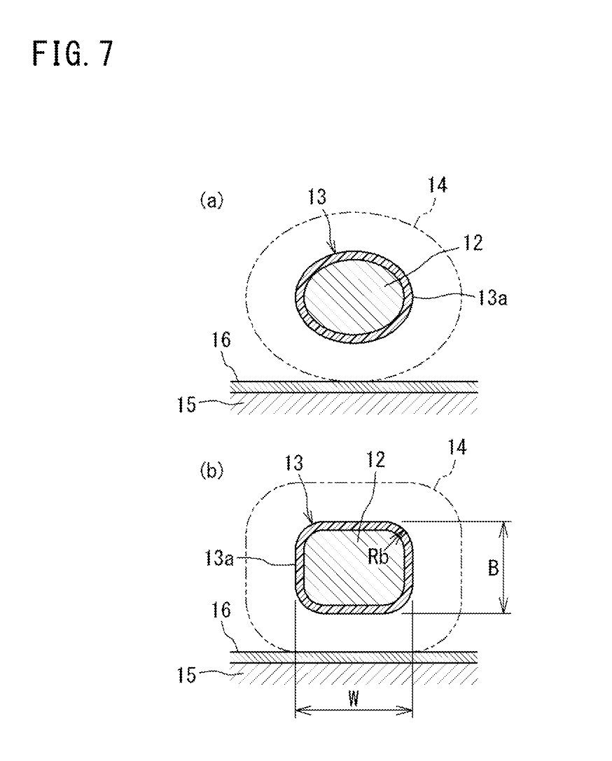

FIG. 7 is a schematic diagram showing two examples of the cross sectional shapes of the inner core 12 and the core body 13a of the bobbin 13. As shown in (a) of FIG. 7, in a case of the inner core 12 and the core body 13a whose cross sectional shapes are each an ellipse as shown in FIG. 1, winding of the coil 14 is easy but the area in which an outermost peripheral portion of the coil 14 comes into direct contact with the heat dissipation sheet 16 is small, and direct heat dissipation performance from the coil 14 to the heat dissipation sheet 16 is not so good. The same applies to a case where the cross sectional shape is a circle. If the cross sectional shape is a rectangle, the coil 14 can be brought into contact with the heat dissipation sheet 16 in a wide area. However, if corners are present, winding of the coil 14 is not easy.

Therefore, as shown in (b) of FIG. 7, a form in which the cross sectional shape is basically a rectangle and corners thereof are rounded is more preferable. In this case, the coil 14 can be brought into contact with the heat dissipation sheet 16 over a wide area, and in addition, winding of the coil 14 is easy. As a result of an experiment, it is preferable that a length W of the long side, a length B of the short side, and a radius of curvature Rb of each corner satisfy the relationship of:

W=1.5×B

Rb=B/3

<Variation of Inner Core and the Like>

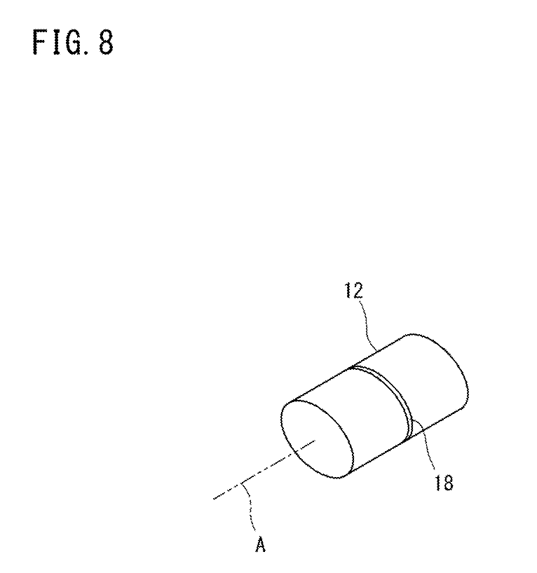

FIG. 8 is a perspective view showing another structure of the inner core 12. In the embodiment described above, the inner core 12 is formed in a core-rod-like shape composed of one piece (FIG. 1). However, as shown in FIG. 8, the inner core 12 may be divided into pieces in the axial direction of the central axis A, and a spacer 18 may be sandwiched between the pieces. This is an example of the inner core 12 divided into two, but the inner core 12 may be divided into three or more. In this case, by forming the spacer 18 from a resin being a non-magnetic material, for example, a magnetic gap can be ensured by the thickness of the spacer 18.

That is, in this case, it is not necessarily required to ensure a magnetic gap by means of the structure of the bobbin 13 as shown in FIG. 2 and FIG. 3. Therefore, the hole-with-bottom 13d of the bobbin 13 may be changed to a through hole, and both end faces of the inner core 12 may be caused to abut against the outer core 11. However, the configuration in which the gap is ensured by the thickness of the bottom of the hole-with-bottom 13d of the bobbin 13 as shown in FIG. 2 and the configuration in which the spacer 18 is sandwiched between pieces of the inner core 12 as shown in FIG. 8 may be used in combination. In such a case, a necessary amount of magnetic gap will be ensured by the total of the thickness of the bottom of the hole-with-bottom 13d and the thickness of the spacer 18. Further, the spacer 18 may not necessarily be a non-magnetic material. For example, by selecting a material that is a magnetic material but has a magnetic resistance greater than that of the inner core 12, the spacer 18 can exhibit action (suppression of magnetic saturation) similar to that of a gap.

<Variation of Bobbin>

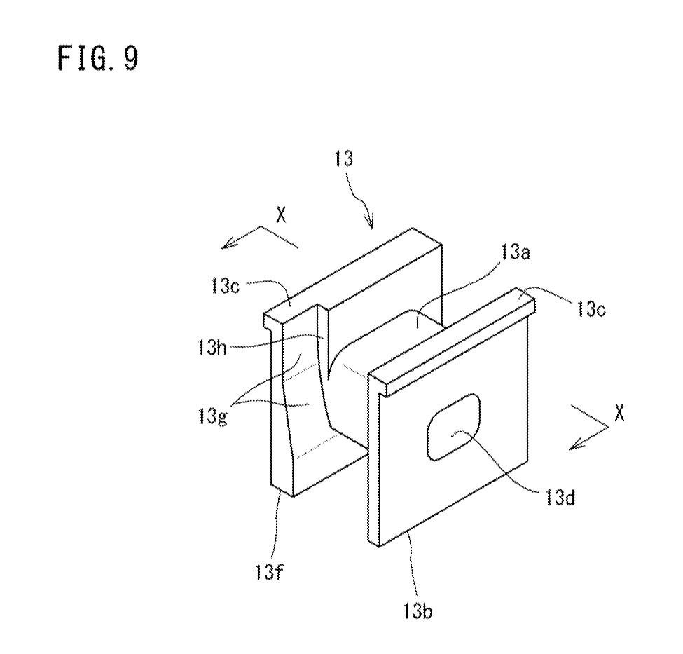

FIG. 9 is a perspective view showing the bobbin 13 according to a variation. As basic features, the bobbin 13 is composed of the core body 13a and collars at both ends thereof, the hole-with-bottom 13d is formed in the core body 13a, and the positioning part 13c is formed in each of the collars, as in the case of the bobbin 13 shown in FIG. 1. However, FIG. 9 shows an example in which the cross sectional shape (contour) of the core body 13a is not an ellipse, but is a rectangle whose four corners are rounded as shown in (b) of FIG. 7.

Major differences between the bobbin 13 shown in FIG. 9 and the bobbin 13 shown in FIG. 1 are, first, that a collar 13f being one of the two collars is thicker than the collar 13b being the other one of the two collars, and that a recessed portion 13g which is recessed relative to the other portion of the collar 13f is formed in the collar 13f. Since the collar 13f is sufficiently thick, the recessed portion 13g can be easily formed. By laying a winding end of the coil 14 along the recessed portion 13g and an end wall 13h thereof, winding of the coil 14 becomes easy.

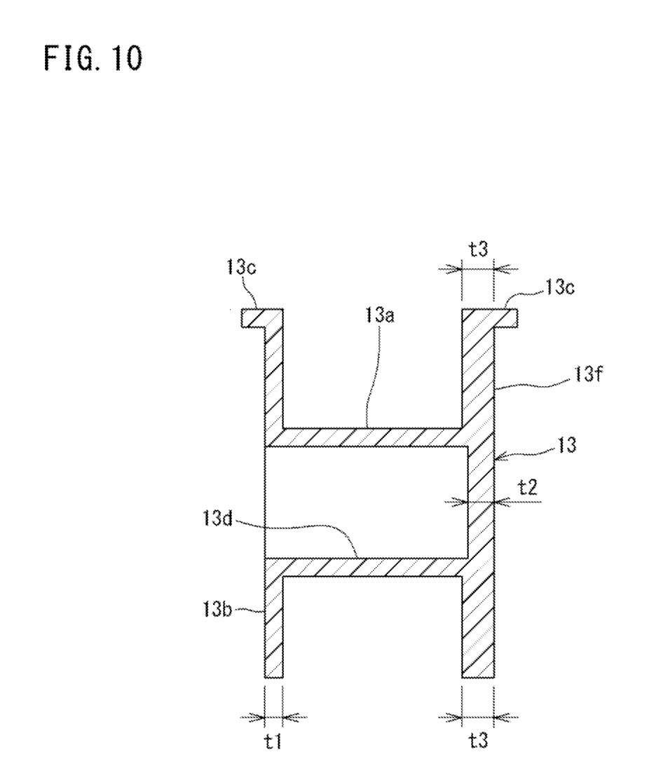

FIG. 10 is a cross sectional view of the bobbin 13 viewed from the X-X line shown in FIG. 9. The bottom of the hole-with-bottom 13d forms a magnetic gap having the thickness t2 as in the case of FIG. 2. However, the collar 13f on the gap side has a thickness of t3, for example, which is greater than the thickness t1 of the collar 13b on the left side.

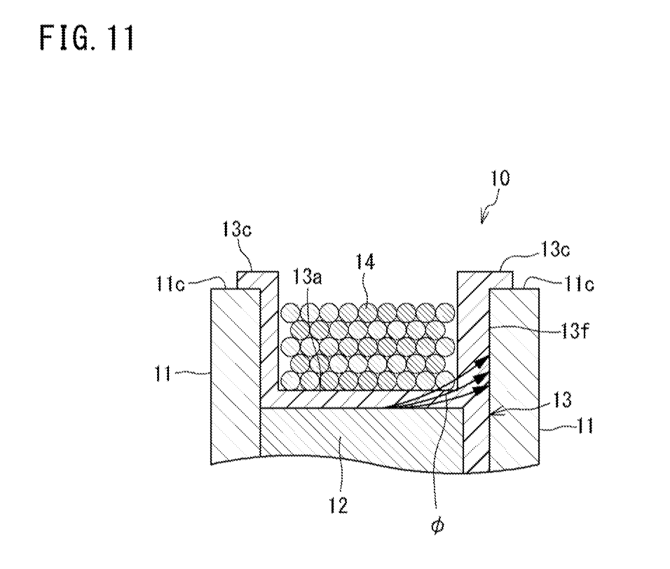

FIG. 11 is a partial cross sectional view showing a state where the bobbin 13 shown in FIG. 10 on which the coil 14 is wound is mounted in the outer core 11. Lines with arrows in FIG. 11 show a state that magnetic flux that should have flowed from the inner core 12 into the outer core 11 has leaked to the outside and has become leakage magnetic flux φ. When the wire of the coil 14 that is close to the right end side of the inner periphery of the outer core 11 is exposed to such leakage magnetic flux φ, an eddy-current loss occurs in the wire, and thus, it is preferable that such wire of the coil 14 is not exposed to the leakage magnetic flux φ as much as possible. Since the collar 13f on the gap side has the greater thickness, the wire is located leftward so as to be away from the leakage magnetic flux φ by the increase in the thickness. As a result, the amount of leakage magnetic flux to which the wire is exposed is reduced. Accordingly, the loss of the choke coil 10 is reduced.

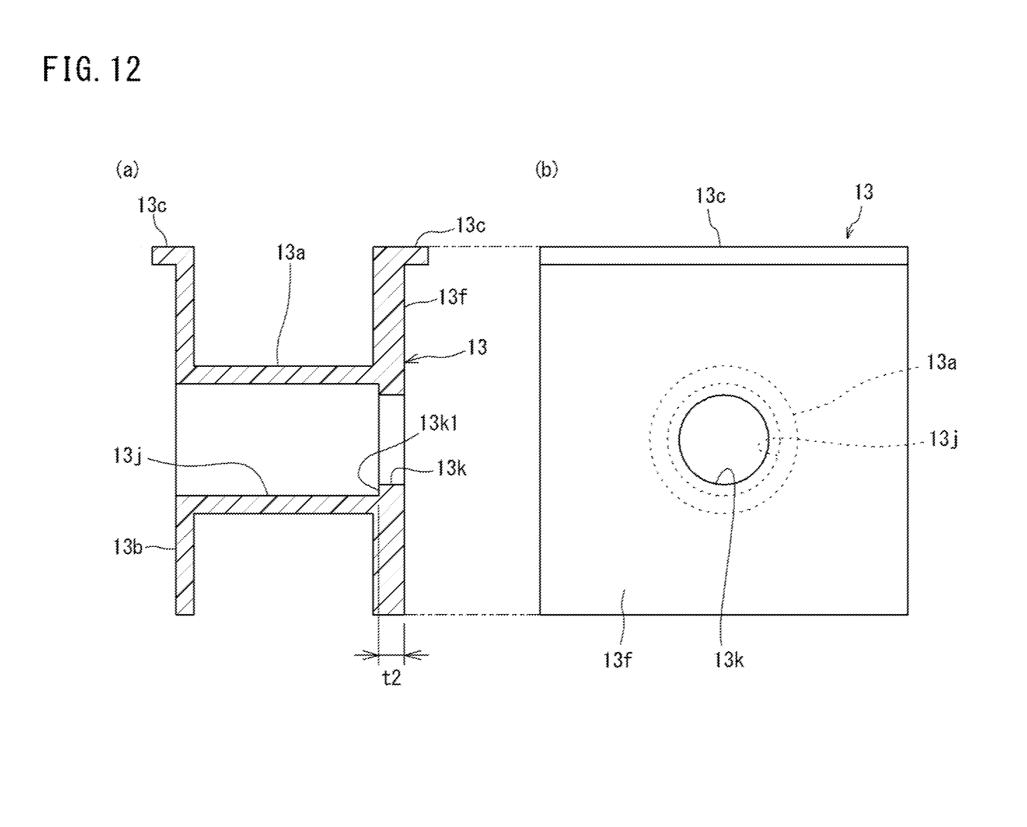

FIG. 12 shows the bobbin 13 according to another variation, in which (a) shows a cross sectional view thereof, and (b) is a side view thereof viewed from the collar 13f side. With respect to the bobbin 13, the bottom of a hole 13j for housing the inner core is partially open and a bottom hole 13k being a through hole is formed. Here, as an example, the inner core has a cylindrical shape, the hole 13j also has a shape corresponding thereto. The diameter of the bottom hole 13k is smaller than the inner diameter of the hole 13j, and thus, an edge 13k1 of the bottom hole 13k serves as a stopper against which the inner core abuts. Further, the thickness (t2) of the edge 13k1 forms a magnetic gap. Forming such a bottom hole 13k provides an advantage that a jig serving as the rotational axis of the bobbin 13 used when a coil is wound on the bobbin 13 can be inserted through the bottom hole 13k. Space in the bottom hole 13k after the coil has been wound may be left as space with nothing stuffed therein, or may be filled with a heat dissipation material or a resin.

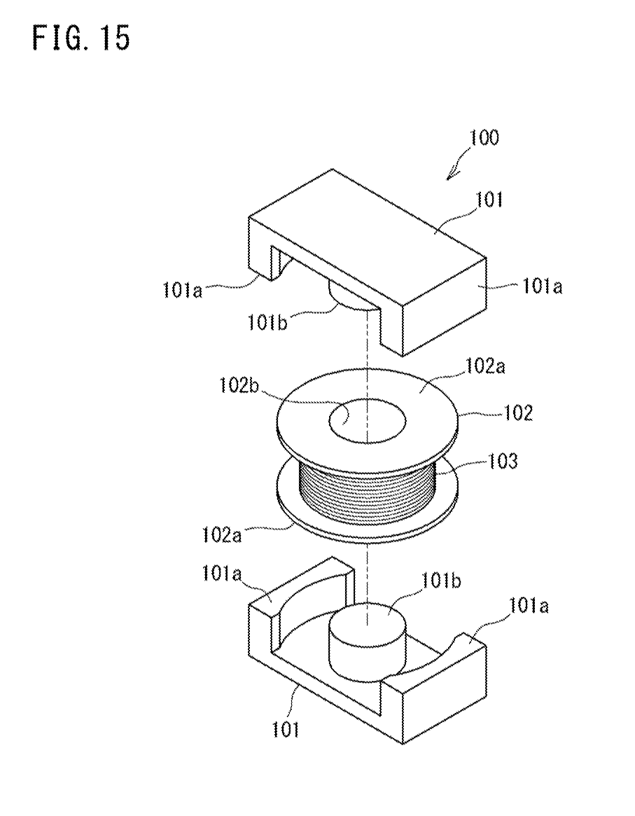

It should be noted that the collar 13b (including the positioning part 13c) or 13f of the bobbin 13 preferably has the shape (quadrangular shape) as shown in FIG. 1, FIG. 9, or FIG. 12, for stable mounting thereof to the outer core 11, for convenience of positioning thereof, and further for improving heat dissipation performance. However, a bobbin having annular collars (102a) (the inner core has a cylindrical shape) as shown in FIG. 15 may be employed. Also in this case, since the outer core and the inner core are made of members different from each other, their shapes are simplified, thus, molding thereof is easy, and it is possible to obtain basic action and effect that the mechanical strength can be easily ensured although dust cores are used.

<Fixation of Bobbin>

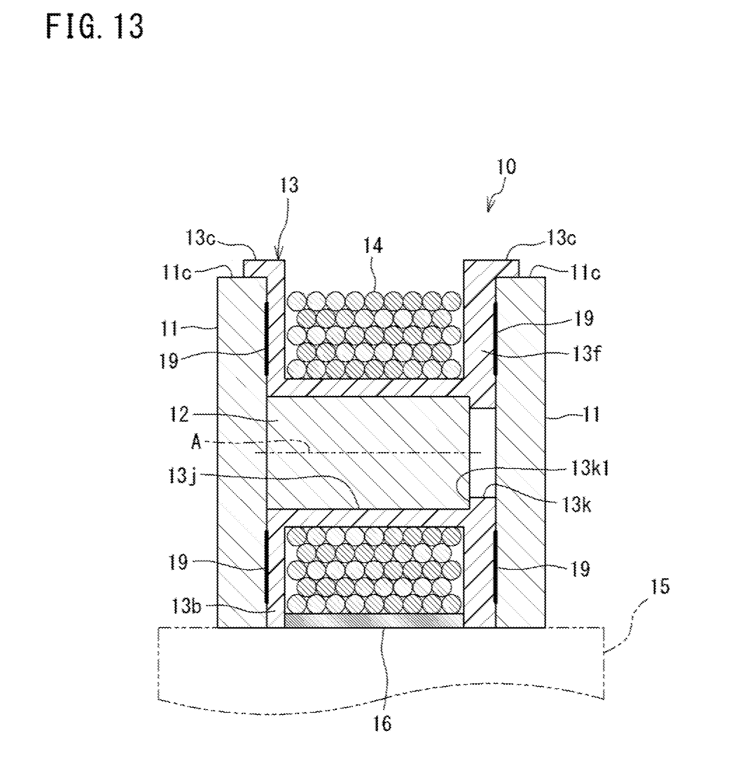

FIG. 13 is a cross sectional view of the choke coil 10 in a case where the bobbin 13 of the type shown in FIG. 12 is used. Normally, the bobbin 13 is tightly mounted in the outer core 11, thereby being stably held in the outer core 11. Further, due to the presence of the positioning parts 13c, the bobbin 13 does not move in the downward direction in FIG. 13. However, in order to fix the outer core 11 and the bobbin 13 with each other more assuredly, it is preferable that the bobbin 13 is inserted into the outer core 11 after application of an adhesive 19. As the adhesive, a silicon-based type is preferred, but an epoxy-based type may also be used.

<Type of Coil>

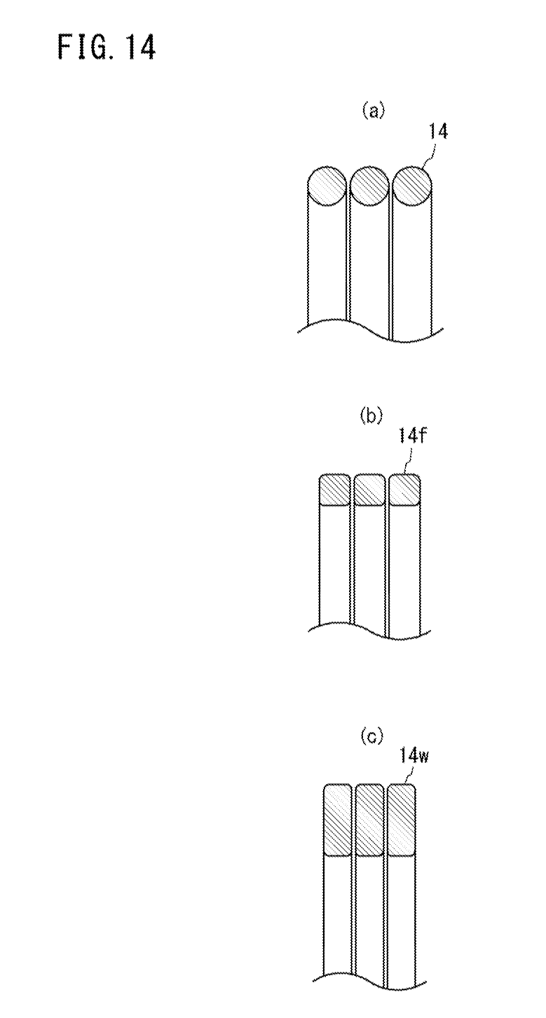

FIG. 14 shows types of the cross sectional shape of a coil. The wire (insulated wire) of the coil 14 shown in FIG. 2 and other figures is a round wire whose cross section is a circle as shown in (a) of FIG. 14. Other than this, a flat wire coil 14f whose cross section is a square shape as shown in (b) of FIG. 14, or an edgewise coil 14w, which is a flat wire whose cross section is a rectangular shape, wound with a short side of the rectangular shape so as to form an inner diameter face as shown (c) of FIG. 14, may be used. The edgewise coil is less easy to be wound than the round wire of (a) and the flat wire of (b), but has a large space factor, and is preferable for a high current.

<Others>

Note that the embodiment disclosed herein is merely illustrative in all aspects and should not be recognized as being restrictive. The scope of the present invention is defined by the scope of the claims, and is intended to include meaning equivalent to the scope of the claims and all modifications within the scope.

### REFERENCE SIGNS LIST

10 choke coil

11 outer core

11b flat surface

11d end face

12 inner core

13 bobbin

13a core body

13b, 13f collar

13c positioning part

13d hole-with-bottom

13g recessed portion

13j hole

14 coil

15 heat dissipation member

17 mold part

18 spacer

1. A choke coil comprising:
an outer core made of a dust core, the outer core having a quadrangular frame shape at least on an inner face side thereof;
a bobbin on which a coil is wound and which is mounted in the frame of the outer core; and
an inner core made of a dust core for serving as a magnetic core of the bobbin, the inner core forming a core-rod-like shape having a central axis parallel to a winding axial direction of the coil, the inner core being interposed between two flat surfaces facing each other in the inner face of the outer core such that the central axis extends in a direction orthogonal to the two flat surfaces.

2. The choke coil according to claim 1, wherein
by the inner core being inserted into a hole formed in a middle of the bobbin, to be housed at a predetermined position therein, one end portion in a direction of the central axis of the inner core abuts against one of the two flat surfaces, and the other end portion in the direction of the central axis of the inner core faces the other of the two flat surfaces while forming a predetermined magnetic gap.

3. The choke coil according to claim 2, wherein
the hole is a hole-with-bottom, and the other end portion faces the other of the two flat surfaces via a thickness of a bottom of the hole-with-bottom.

4. The choke coil according to claim 2, wherein
collars are respectively formed at both ends of the bobbin, the collar at one end thereof is thicker than the collar at the other end thereof, and the gap exists on the collar at one end side.

5. The choke coil according to claim 4, wherein
in the collar at one end, a recessed portion along which a winding end of the coil is laid is formed.

6. The choke coil according to claim 1, wherein
the inner core is divided into a plurality of pieces in the direction of the central axis thereof, and a member which serves as a magnetic gap is sandwiched between the plurality of pieces.

7. The choke coil according to claim 1, wherein
the bobbin is provided with a positioning part for aligning the central axis of the inner core to a center of each of the two flat surfaces.

8. The choke coil according to claim 1, wherein
a portion of an outermost layer of the coil wound on the bobbin is exposed to a one end face side of the frame of the outer core, and is present further inside the outer core relative to the one end face, and a heat dissipation member is provided so as to face the one end face and the portion of the outermost layer.

9. The choke coil according to claim 1, wherein
each of the dust cores respectively forming the outer core and the inner core is obtained by subjecting soft magnetic powder coated with insulation coating to compression molding and thermal treatment, and an average particle diameter of the soft magnetic powder is about 150 μm.

10. The choke coil according to claim 1, wherein
a shape of a cross section of a site of the bobbin on which the coil is wound, the cross section being orthogonal to the winding axial direction, is a rounded outwardly-protruding curve including a circle and an ellipse, or a polygon whose corners are rounded.

11. The choke coil according to claim 1, wherein
the coil and the bobbin are molded together by filling a resin between both end faces of the frame of the outer core.
